(19) United States
(12) Patent Application Publication
(10) Pub. No.: US 2018/0192618 A1
(43) Pub. Date: Jul. 12, 2018

(54) SYSTEM FOR CAPTURING AND TRANSMITTING LIVESTOCK DATA

(71) Applicant: Abdul SAMAD, Maharashtra (IN)

(72) Inventors: Abdul SAMAD, Maharashtra (IN); Prashant MURDESHWAR, Maharashtra (IN); Zohaib HAMEED, Alberta (CA)

(21) Appl. No.: 15/739,701

(22) PCT Filed: Jun. 24, 2016
(86) PCT No.: PCT/IB2016/053769

§ 371 Date: Dec. 22, 2017

(30) Foreign Application Priority Data
Jun. 24, 2015 (IN) 2402/MUM/2015

(51) Int. Cl. A01K 29/00; A01K 11/00; H04W 4/14; G06F 17/30; G06Q 10/10

(52) U.S. Cl. CPC A01K 29/005; A01K 11/008; G06Q 10/10; G06F 17/30002; G06F 17/30979; H04W 4/14

(57) ABSTRACT

The present disclosure relates to management of livestock, and more particularly to a secure and credible system, architecture, and method for uniquely and credibly identifying, capturing, updating and maintaining livestock herd data.

### FIELD OF DISCLOSURE

The present disclosure relates to management of livestock, and more particularly to a secure and credible system, architecture, and method for capturing, updating and maintaining livestock data.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

World has become a small close knit community and events occurring even in far remote locations can affect any corner of the world. This is very true for diseases, germs, viruses, etc., spread through animals as was seen during the mad cow disease and bird flu pandemics/epidemics. Therefore, today, economic, health, disease, pandemic/zoonotic disease monitoring and control mechanisms, productivity enhancement, quality assurance aspects, and other such factors dictate for having real time and updated database of all livestock for efficient management of the livestock. Though the requirement is simple, implementation, mainly because of cost implications, is difficult.

An important factor for tracking and recording data pertaining to livestock/food animals/their progeny/produce is linked to identification and traceability. At present, domestic animals such as cattle, buffalo, sheep, goat, swine, etc., are identified for the purpose of performance recording by diverse ways, such as, (a) simple plastic ear tags printed with visual number and single dimension bar code, (b) electronic plastic ear tags embedded with RFID chip printed with visual number & bar code and (c) inserts embedded with RFID microchip and injected or deposited in to the skin or rumen. In case of simple plastic ear tags, identification number is printed with permanent ink in definite alphanumeric numbers (12 to 15) as per the national or international standards (ICAR 2009). These tags are cheap and easy to apply but have important constraints such as: (a) the number cannot be read electronically, and hence the identification number and the data need to be typed each time new data is to be updated, making it prone to errors; and (b) there is always a question mark on correctness of data as its location of update from farm or otherwise cannot be ascertained. RFID tags are electronic identification devices proven to be more reliable as these can be read from a near-distance with electronic readers. Passive RFID tags however also have constraints for large scale adoption in small hold livestock production systems, wherein such constraints are due to: (a) RFID tags are expensive for resource-poor farmers and additionally expensive dedicated readers are needed, making use thereof beyond the financial capacity of the poor farmers; (b) passive RFD tags store only identification number, whereas due to space limitation, other important details of the animals cannot be stored. If data is to be updated in herd management software manually or digitally, a dedicated device that can scan RFID and also transmit data is needed. Such devices are quite expensive and beyond capacity of the para-vet and veterinarians in developing and under-developed countries. RFID therefore is suitable only for mechanized intensive farms. For small farmers, therefore a simple to roll out and cost effective system that satisfies the critical need of eliminating possibility of update of fictitious data is needed.

Though many methods and systems are available and disclosed in the prior arts for creating of database and management of livestock, these systems are generally costly to implement and can deter poor farmers from adapting and implementing such systems. Another drawback of these systems is that they do not have any method/procedure for checking or preventing personnel from making fraudulent entry/editing of databases, and can often happen because livestock may be located in far off remote and not easily accessible locations.

U.S. Pat. No. 6,664,897 issued to William R. Pape et al, for a ‘Method and system for livestock data collection and management’ discloses a system for livestock data collection and management to provide quality assurance source verification data and performance tracking for individual animals throughout the production cycle using RFID tags for individual animals. Only a limited amount of data can be stored on RFID readable tags and big infrastructure in terms of RFID readers and other support systems are required for implementation of such systems.

U.S. Pat. No. 5,322,034 issued to Richard L. Willham, for a “Livestock Record System” describes a method for storing the individual animal's identification and performance data on a programmable electronic identification and data storage module carried with the animal. However, this can be manipulated by either using the same tag for multiple animals or attaching the same tag to a different animal.

Thus there is a requirement for a low cost livestock herd database management system, whereby livestock data management can be achieved in more secure and credible manner without requirement of any special infrastructure.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

It is an object of the present disclosure to provide an ear tag printed with, in addition to visual identification number, one or more dynamic shortened URL in QR code format with string to connect users to animal's data file on a web-server to enable traceability.

It is an object of the present disclosure to provide an ear tag printed with URL and/or SMS, and a string in QR code that, apart from identification number, can also carry animal's data for update and traceability.

It is an object of the present disclosure to provide an ear tag or premises card printed with generic or non-generic two dimensional bar code encrypted with unique identification number and query string to direct the operator to the data file saved on local database in scanning device.

It is an object of the present disclosure to provide a low cost and efficient QR code based secure, credible, and efficient livestock data collection system that can be interfaced with any herd database management system installed for instance on cloud, central server or local database.

It is an object of the present disclosure to provide a low cost and efficient QR code based secure, credible, and efficient identification and data capturing system that can function using peripheral devices.

It is an object of the present disclosure to provide a livestock data capturing system based on user and livestock authentication.

It is an object of the present disclosure to provide a livestock data capturing system whereby users can be authenticated based on their mobile number/SIM number.

It is an object of the present disclosure to disclose a livestock data capturing system whereby livestock data can be validated using GIS location information.

### SUMMARY

The present disclosure mainly relates to the field of livestock herd management, and in particular to a secure and credible system and method for uniquely and credibly identifying, capturing, updating and maintaining livestock herd data. Although the present disclosure has been explained with help of a number of livestock location premises, it should be appreciated that this is not a limitation of the disclosed invention. In an aspect, the present disclosure is not limited either by the number of livestock location premises or by the number of livestock/animals held in any one premise/location. The number of livestock location premises can vary from one to hundreds or even more, and similarly number of animals in any livestock location premise can vary from few to lakhs or even more. In another aspect, the present disclosure can be used for database management of different types of animals either co-located at one site, or different types of animals' segregated or located at multiple livestock location premises/herding sites.

Embodiments of the present disclosure disclose a system where a farmer/veterinary/para-veterinary/manager/service provider/among another stakeholder is located at the livestock location premises such as at a farmhouse/ranch/dairy/etc., and can be operatively coupled, through peripheral devices such as mobile phones, smart phones, tablet PCs, Laptops, Computers, among others, with and without Internet connectivity, with a remotely located livestock herd management server/(s) for storing/updating/editing/management of livestock data through, say a cloud based application.

In an embodiment of the present disclosure, functional modules of the proposed architecture can include any livestock herd management system, wherein the proposed system can include a peripheral device based registration module, a peripheral device based authentication module, a peripheral device based data validation module, and a peripheral device based data updation module.

In an aspect, the peripheral device based registration module can be configured to enable a user to register with and/or create a new record/data of the farmers and his one or more livestocks, and/or update/edit/modify existing records stored in a database of the proposed livestock herd management system. In another aspect, peripheral device based authentication module can be configured to enable authentication of a peripheral device on the system, wherein such authentication can be based on cell number/SIM number/IP address of the peripheral device.

In yet another aspect, peripheral device based data validation module can be configured to enable validation of data being uploaded/edited/modified on the proposed system through peripheral device, wherein such validation can include checking and confirming cell number/SIM number/IP address of peripheral device being used to upload/edit/modify record/data on the system of the present disclosure, along with verifying whether the data being uploaded is authentic, correctly captured, and verifiable/auditable. In yet another aspect, for the data being uploaded/edited/modified using an SMS template, such validation can include SMS pull and segregation protocol, wherein the validation process can include source authentication based on cell number of the peripheral device from which the SMS can be received, followed by segregation of data based on type/category of data and SMS coded keywords to determine authenticity of new/existing records.

In another embodiment of the present disclosure, peripheral device, also simply referred to as device or “computing device” hereinafter, can include a QR code based scanning module, a QR code based linking module, and a QR code based event data entry form module. In an aspect, the QR code based scanning module can be configured to enable a peripheral device to scan QR coded ear tag and/or premises/animal identification card. In another aspect, QR code based linking module can be configured to enable the peripheral device to read a short URL, or generic code that is embedded in the QR code ear tag and/or premises/animal identification card, and allow the peripheral device to connect with the animal file stored in the server or local database to enable displaying of event data entry form or reports.

In an exemplary embodiment, the QR code generated can include encrypted information. In an exemplary implementation, information associated with the animal or other program strings can be encrypted and converted to specific QR code and printed on the ear tag and/or premises/animal identification card or any other object. In an exemplary implementation, the QR code based scanning module can be configured to enable the peripheral device to scan a QR code, which may include encrypted information, and decrypt the encrypted information/program strings, such as animal's identification number or unique livestock or other premises number or any other unique program string generated. The scanned QR code can be processed by employing a dedicated program/application specially written for the purpose to decrypt the encrypted information stored in form of QR code.

The QR code can be scanned using the dedicated application having capability to decrypt the encrypted information/program strings converted into the QR code. The dedicated application can be configured at registered peripheral device, for example a cell phone. The WR code based linking module can be configured to enable linking/opening of animals' data file for browsing or data update once the scanned information is decrypted by the QR code based scanning module. Storing the program strings/information in encrypted form and enabling access of information only by registered peripheral device, enables high data credibility and security. In an exemplary implementation, the peripheral device may have local database which can be accessed by the dedicated application for retrieving information associated with QR code and update part of the information or add new data. The dedicated application can scan the QR code to identify the content associated with the animal/livestock or premises and update relevant data or add new data even when the peripheral device is away from the internet/data connection. The dedicated application can save/sync the updated data present on the local database on the central server as and when the peripheral device gets the internet access. The system therefore will be valuable in remote rural areas where animals are reared but internet connectivity is poor. Another advantage of the system is that the ear tag code can be scanned only by service providers or other officers of the organizations whose cell phone numbers/peripheral devices are registered. Only authorized persons will have access to the animal's data. The system therefore also confers substantial confidentiality to the data.

In an exemplary implementation, the peripheral device get data associated with the QR code or animal for the firm time, when the peripheral device gets scans the QR code and is connected to the central server. All relevant information associated with the particular animal or livestock premises can be uploaded or stored locally on the peripheral device, so as to enable access of relevant data even in offline mode.

In another embodiment of the present disclosure, device of the present disclosure can include a QR code based SMS template generation module that can be configured to enable generation of a standardized and pre-configured SMS template, which can in turn be used by the device users for updating/editing/modifying livestock database on the server.

The present disclosure further relates to a method for printing of QR code tag and/or visual ID number on ear tags and/or premises cards based on unique identification number, wherein the method can include the steps of generating a Unique Identification Number (UIN) based on an assigned series as per the national or international standards (ICAR 2009). The method can further include the step of creating a query string based on the UIN, and generating a long/dynamic URL based on the query string created with the UIN. The method can further include the step of interfacing the dynamic URL to database format and livestock(s)/premise(s) data file of the proposed system, and generating a QR Code based on the UIN, based on which the method can then include the step of printing such QR code and/or visual ID number on the ear tag and/or the premises card, which can be attached to each livestock to uniquely and separately identify each animal.

In another aspect, dynamic URL generated based on the UIN can be converted to a short URL, wherein the short URL can be used for generating a SMS encrypted QR Code, and wherein such SMS QR code can be printed on ear tag and/or premises card. Furthermore, such SMS encrypted QR code can be scanned through peripheral devices for updating/editing/modifying livestock database on the livestock herd database management server.

In another aspect the UIN can itself be converted into QR code encrypted with query string for accessing file from the local database of the scanning device.

In another embodiment, livestock herd management system can provide a simple method for transfer of ownership of a livestock/animal from one owner to another, wherein such transfer can be performed at the server level by scanning of QR code ear tag of a livestock/animal being transferred using a device, and downloading requisite data file relating to the livestock on the device. Once the requisite data file is downloaded, a livestock transfer option can be selected and the requisite data file can be accordingly updated to reflect change in ownership in the server. Such transfer request can necessitate further authentication of user through a defined user name and password or any other authentication means. Identification details of the new owner can be entered into the system, upon which the data file of the livestock can be transferred and linked to the new owner. In another aspect, the new owner can again scan QR Code Ear Tag of the transferred animal with their peripheral device in order to confirm the transaction through respective user name and password.

In another embodiment of the present disclosure, data file from a central server or local database of the proposed system can be directly downloaded and viewed by user/owner farmer by scanning QR Code of the animal by using a registered peripheral device. In another aspect, if required by a third party, a report can directly be sent from the central server of the proposed system.

In another aspect, for owners/users who are not having access through Internet, information about animal can be obtained by scanning QR Code Ear Tag, wherein such scanning can generate a template code, which can be sent to a SMS server using registered peripheral device/cell phone and can allow for owner/user to receive an SMS containing required information.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The diagrams are for illustration only, which thus is not a limitation of the present disclosure, and wherein:

FIG. 1 illustrates an exemplary architecture of a Livestock Herd Database Management system of the present disclosure in accordance with an embodiment of the present disclosure.

FIG. 2 illustrates exemplary functional modules of a Livestock Herd Database Management system of the present disclosure in accordance with an embodiment of the present disclosure.

FIG. 3A and FIG. 3B illustrate exemplary functional modules of Peripheral Device of a Livestock Herd Database Management system of the present disclosure in accordance with an embodiment of the present disclosure.

FIG. 4A illustrates exemplary method for on-line printing of QR Coded Ear Tag and Premises Card of a Livestock Herd Database Management system of the present disclosure in accordance with an embodiment of the present disclosure.

FIG. 4B illustrates exemplary method for on-line printing of QR Coded Ear Tag and Premises Card of a Livestock Herd Database Management system of the present disclosure in accordance with an embodiment of the present disclosure.

FIG. 5 illustrates exemplary data update protocol and process using dynamic URL-QR code of a livestock Herd Database Management System of the present disclosure in accordance with an embodiment of the present disclosure.

FIG. 6 illustrates exemplary data update protocol and process using SMS-QR code of a Livestock Herd Database Management System of the present disclosure in accordance with an embodiment of the present disclosure.

FIG. 7 illustrates an exemplary QR Coded Premises Card of a Livestock Herd Database Management system of the present disclosure in accordance with an embodiment of the present disclosure.

FIG. 8 illustrates an exemplary QR Coded Ear Tag of a Livestock Herd Database Management system of the present disclosure in accordance with an embodiment of the present disclosure.

FIG. 9 illustrates exemplary screen shot of SMS template of a Livestock Herd Database Management system of the present disclosure in accordance with an embodiment of the present disclosure.

FIG. 10 illustrates an exemplary block diagram of the system enabling retrieval of encrypted information stored in form of QR code and enabling updation of data in offline mode in accordance with an embodiment of the present disclosure.

### DETAILED DESCRIPTION OF DRAWINGS

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present invention, Livestock Herd Database Management system has been described with respect to a centralized server, it should be appreciated that the same has been done merely to illustrate the invention in an exemplary manner and any other purpose or function for which explained structure or configuration can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

The present disclosure mainly relates to the field of livestock herd management, and in particular to a secure and credible system and method for uniquely and creditably identifying, capturing and updating of livestock data. Although the present disclosure has been explained with help of number of livestock location premises, it should be appreciated that this is not a limitation of the disclosed invention. In an aspect, the present disclosure is not limited by either number of livestock location premises, or to the number of livestock/animals held in any one premise/location. The number of livestock location premises can vary from one to hundreds or even more and similarly number of animals in any livestock location premise can vary from few to lakhs or even more. In another aspect, the present disclosure can be used for database management of different types of animals either co-located at one site or different types of animals' segregated or located at multiple livestock location premises/herding sites.

Embodiments of the present disclosure disclose a system wherein a farmer/veterinary/para-veterinary/manager/service provider/among other stakeholder is located at livestock location premises such as at a farmhouse/ranch/dairy/etc., and can be operatively coupled through QR coded ear tags or premises card which in turn can be coupled with any peripheral devices such as mobile phones, smart phones, tablet PCs, Laptops, Computers, among others, with and without Internet connectivity, and with a remotely located livestock herd management server/(s) for storing/updating/management of livestock data through cloud based application.

In an embodiment of the present disclosure, functional modules of the proposed architecture can include any livestock herd management system, wherein the proposed system can include any peripheral device based registration module, a peripheral device based authentication module, a peripheral device based data validation module, and a peripheral device based data updation module.

In an aspect, the peripheral device based registration module can be configured to enable a user to register with and/or create a new record/data and/or update existing records stored in database of the herd management system.

In another aspect, the peripheral device based authentication module can be configured to enable authentication of a peripheral device on the system, wherein such authentication can be based on cell number/SIM number/IP address of the peripheral device.

In yet another aspect, peripheral device based data validation module can be configured to enable validation of data being uploaded/edited/modified on the proposed system through peripheral device, wherein such validation can include checking and confirming cell number/SIM number/IP address of peripheral device being used to upload/edit/modify record/data on the system of the present disclosure. In yet another aspect, for record/data being uploaded/edited/modified using SMS Template, such validation can include SMS pull and segregation protocol, wherein such validation process can include source authentication based on cell number of peripheral device from which SMS can be received, followed by segregation of data based on type of data, and SMS coded keywords and authenticity of new record.

In another embodiment of the present disclosure, peripheral device, also simply referred to as device or “computing device” hereinafter, can include a QR Code based scanning module, a QR based linking module, and a QR based event data entry form module. In an aspect, the QR Code based scanning module can be configured to enable a peripheral device to scan a QR coded ear tag and/or premises/animal identification card. In another aspect, QR based linking module can be configured to read a short URL and dynamic URL embedded in the QR Code Ear tag and/or Premises/Animal Identification Card and allow the Peripheral Device to connect with livestock herd management server and/or enable the QR based event data entry form module to open an event data entry form on linked peripheral Device for editing a database connected to the particular livestock.

In an exemplary embodiment, the QR code generated can include encrypted information. In an exemplary implementation, information associated with the animal or other program strings can be encrypted and converted to specific QR code and printed on the ear tag and/or premises/animal identification card or any other object. In an exemplary implementation, the QR code based scanning module can be configured to enable the peripheral device to scan a QR code, which may include encrypted information, and decrypt the encrypted information/program strings, such as animal's identification number or unique livestock or other premises number or any other unique program string generated. The scanned QR code can be processed by employing a dedicated program/application specially written for the purpose to decrypt the encrypted information stored in form of QR code.

The QR code can be scanned using the dedicated application having capability to decrypt the encrypted information/program strings converted into the QR code. The dedicated application can be configured at registered peripheral device, for example a cell phone. The WR code based linking module can be configured to enable linking/opening of animals' data file for browsing or data update once the scanned information is decrypted by the QR code based scanning module. Storing the program strings/information in encrypted form and enabling access of information only by registered peripheral device, enables high data credibility and security. In an exemplary implementation, the peripheral device may have local database which can be accessed by the dedicated application for retrieving information associated with QR code and update part of the information or add new data. The dedicated application can scan the QR code to identify the content associated with the animal/livestock or premises and update relevant data or add new data even when the peripheral device is away from the internet/data connection. The dedicated application can save/sync the updated data present on the local database on the central server as and when the peripheral device gets the internet access. The system therefore will be valuable in remote rural areas where animals are reared but internet connectivity is poor. Another advantage of the system is that the ear tag code can be scanned only by service providers or other officers of the organizations whose cell phone numbers/peripheral devices are registered. Only authorized persons will have access to the animal's data. The system therefore also confers substantial confidentiality to the data.

In an exemplary implementation, the peripheral device get data associated with the QR code or animal for the firm time, when the peripheral device gets scans the QR code and is connected to the central server. All relevant information associated with the particular animal or livestock premises can be uploaded or stored locally on the peripheral device, so as to enable access of relevant data even in offline mode.

In another embodiment of the present disclosure, device of the present disclosure can include a QR Code Based SMS Template Generation that can enable generation of a standardized and pre-configured SMS template, which can in turn be used by the device users for updating livestock database on Livestock Herd Database Management Server.

The present disclosure further relates to a method for on-line printing of QR Code tag and/or visual ID number on Ear Tags and/or Premises Cards based on unique identification number, wherein the method can include the steps of generating a Unique Identification Number (UIN) based on an assigned series as per the national or international standards (ICAR 2009). The method can further include the step of creating a query string based on the UIN, and generating a long/dynamic URL based on the query string created with the UIN. The method can further include the step of interfacing of the dynamic URL to database format and livestock(s)/premise(s) data file of the proposed system, and generating a QR Code based on the UIN, based on which the method can then include the step of on-line printing of such QR code and/or Visual ID number on the ear tag and/or premises card, which can be attached to each livestock to uniquely and separately identify each animal.

In another aspect, dynamic URL generated based on the UIN can be converted to a short URL, wherein the short URL can be used for generating a SMS Encrypted QR Code, and wherein such SMS Encrypted QR Code can be printed on Ear Tag and/or Premises Card. Furthermore, such SMS Encrypted QR Code can be scanned through peripheral devices for updating livestock database on the Livestock Herd Database Management Server.

In another embodiment, livestock herd management system can provide a simple method for transfer of ownership of a livestock/animal from one owner to another, wherein such transfer can be performed at the server level by scanning of QR Code Ear tag of a livestock/animal being transferred using a device, and downloading requisite data file relating to the livestock on the device. Once the requisite data file is downloaded, a livestock transfer option can be selected and the requisite data file can be accordingly updated to reflect change in ownership in the server. Such transfer request can necessitate further authentication of user through a defined user name and password or any other authentication means. Identification details of the new owner can be entered into the system, upon which the data file of the livestock can be transferred and linked to the new owner. In another aspect, the new owner can again scan QR Code Ear Tag of the transferred animal with their peripheral device in order to confirm the transaction through respective user name and password.

In another embodiment of the present disclosure, data file from a central server of the proposed system can be directly downloaded and viewed by user/owner farmer by scanning QR Code of the animal by using a registered peripheral device. In another aspect, if required by a third party, a report can directly be sent from the central server of the proposed system.

In another aspect, for owners/users who are not having access through Internet, information about animal can be obtained by scanning QR Code Ear Tag, wherein such scanning can generate a template code, which can be sent to a SMS server using registered peripheral device/cell phone and can allow for owner/user to receive an SMS containing required information.

In another embodiment, QR Coded Ear Tags and/or QR Coded Premises Cards can be made from synthetic polymer/plastic/recycled paper/any other printable material. In another aspect QR Coded Ear Tags with visible Unique Identification Number can be made of polyurethane or any other polymeric, synthetic, metallic or any other suitable material. In another aspect, secure, highly credible and reliable data at any time can be provided to bankers, insurance companies, other regulatory bodies of livestock herd held at livestock premises through Livestock Herd Database Management System of the present disclosure.

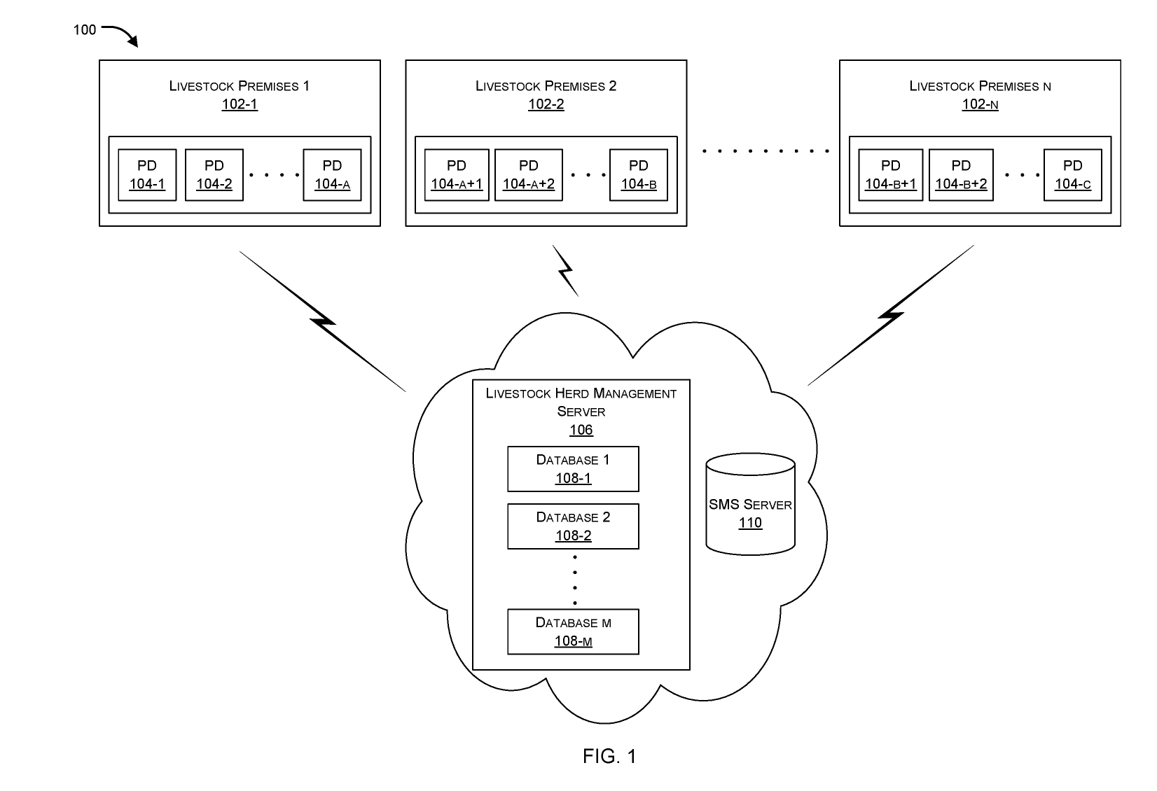

FIG. 1 illustrates an exemplary architecture of a Livestock Herd Database Management system 100 of the present disclosure, wherein such system 100 can include one or more Livestock Premises 102 that can be operatively coupled, individually or collectively through one or a plurality of Peripheral Device(s), with a Livestock Herd Management Server 106 and an SMS Server 110. Livestock Premises 102-1, 102-2, 102-3 . . . 102-N, (together and collectively further referred as LP site 102 hereinafter) can stock/hold number of and different or same type of livestock, wherein such number can extend from few hundred or less to several lakhs or more.

In an aspect, each LP site 102 can be operatively coupled with at least one peripheral device (PD) 104 such as a mobile phone, a smart phone, a tablet PC, among other like devices, which can, through Internet or without, be operatively coupled with the server 106 and/or with the SMS server 110. In an aspect, livestock held at LP site 102 can be tagged with a QR Coded Ear Tag and/or with a visual Unique Identification Number (UIN) or with a QR Coded Premises Card, wherein the QR Coded Ear Tags can be scanned using the respective PD 104 to uniquely identify the livestock from a group, and extract information relating to the scanned livestock, in the form of say a file, from database 108 of the server 106.

According to one embodiment, server 106 can include a plurality of local or remotely configured databases 108 that can include unique database files of each livestock, wherein such files can be identified based on the unique QR code of the livestock/animal such that coupling of the PD 104 with one or more databases 108 can enable presentation of most likely event form on the display of the PD 104, using which a user/authorized person can update the livestock record. In another aspect, updating/editing/modifying of the livestock record on a database of the server 106 can be done after data sender's validation, and wherein such validation can be based on matching of GPS location of PD 104 with registered GIS record of the premises from where the data is being updated.

In another aspect, QR Coded Ear Tag and/or Premises Card can be scanned using a PD 104, wherein a standardized and pre-configured QR Coded SMS template can be enabled on the PD 104. QR Coded SMS template can then be used to send SMS through the SMS Server 110 to access database file/records and/or for updating of the livestock from the server 106. In another aspect, updating of livestock record through QR Coded SMS template can only be done after validation and authentication of data sender's credentials. In another aspect, data validation for SMS based updating can include SMS pull and segregation protocol, wherein such validation process can include source authentication based on cell/phone number of the PD 104 from which SMS can be received, followed by segregation of data based on type of data and SMS coded keywords and authenticity of new record.

In another aspect, though modification of the database/record can be done using PD 104, it should be understood that such updation can be done by farm personnel carrying such PD 104, wherein such farm personnel can include farmers, veterinary and para-veterinary personnel's, animal inspectors, insurance agents, bankers, personnel from regulatory bodies, etc, and wherein authentication/identification/validation of such personnel can be done based on cell number/SIM number and GPS location of their PD 104.

In an exemplary embodiment, database 108-1 can be configured to store data pertaining to livestock/animals held at LP 102-1, and database 108-2 can be used to store records pertaining to livestock/animals held at LP 102-2, and so on. In another alternate embodiment, information of all livestocks in a defined location/state can be stored in a single database. In another exemplary embodiment, record/data pertaining to all livestock/animals held at different LP 102 sites can be kept in one common database. In yet another aspect, separate servers can be used to hold record/database of livestock/animals held at different LP 102 or each database 108 can be used to store a defined type/parameter/attribute of livestock information. Any other configuration/arrangement of livestock data/records to be stored in one or more servers 106 is completely within the scope of the present disclosure.

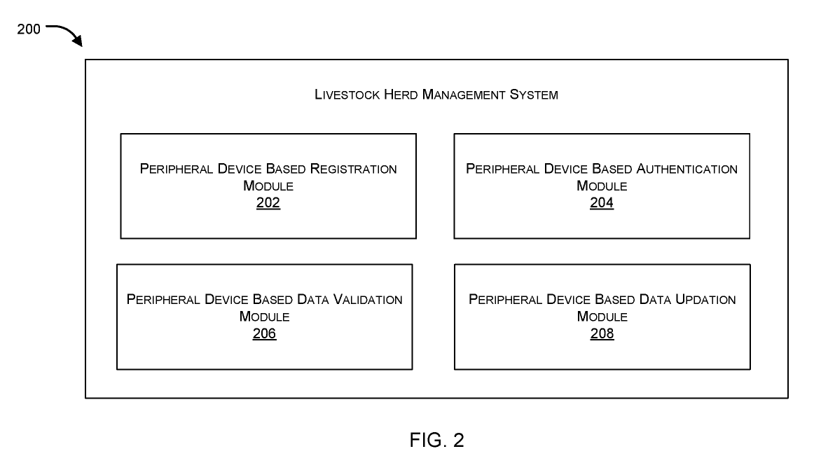

FIG. 2 illustrates exemplary functional modules of a Livestock Management system 200 having a peripheral device based registration module 202, a peripheral device based authentication module 204, a peripheral device based data validation module 206, and a peripheral device based data updation module 208. In an aspect, the peripheral device based registration module 204 can be configured to enable a farmer/veterinary/para-veterinary/manager/etc., to scan QR Code using a peripheral device to get connected to the proposed system 200, and to request to display registration format on the peripheral device. The registration form can enable to register as an authorized user with the system 200, wherein such registration details can include GIS location parameters of the livestock location site. In an aspect, data for livestock/animals can only be added/appended to the database that is configured in the system 200 by registered users. In another aspect, registration form displayed on the peripheral device can be used to register all livestock/animals held at livestock location site by scanning a QR coded tag, whereby most-likely-event form can be displayed on the screen of the peripheral device.

In another aspect, the peripheral device based authentication module 206 can be configured to authenticate a user before he/she updates any data/record on the system 200/database, wherein such authentication can be based on any or a combination of cell number, SIM number, IP address, unique identification code of the user, and GIS location of the peripheral device. In an aspect, only data that is uploaded from a registered peripheral device and from correctly identified GIS location can be accepted for creating a record/or updation or an existing record in the database of the proposed system 200.

In another aspect, peripheral device based data validation module 208 can be configured to validate data being sent from a device for creating a new record in database or for updating an existing record/data, wherein such validation can be based on checking any or a combination of cell number, SIM number, and/or IP address of the peripheral device and/or matching of GPS location of peripheral device with registered GIS record of the livestock premises. In an exemplary implementation, the authentication process can be trigged only if the QR code scanned by the peripheral device can be decrypted by a dedicated application configured to decrypt information stored, if the data stored in QR code were encrypted. In another aspect, when updation of data is done using an SMS template, validation can be based on SMS pull and segregation protocol, wherein such validation process can include source authentication based on cell number of peripheral device from which SMS can be received, followed by segregation of data based on type of data and SMS coded keywords and authenticity of new record.

In an exemplary implementation, the system 200 can include a QR code generation application that can generate QR code to be printed on ear tag and/or premises/animal identification card. In an exemplary implementation, the QR code generation application can receive information, for example identification information, location information etc. associated with the animal, livestock or premises, and encrypt the received information or generate QR code. Information, for example ID information, URL etc. stored in the QR code can't be accessed merely by scanning the QR code, if they are stored in encrypted form. In an exemplary implementation, a dedicated application can be provided for scanning the QR code and decrypting the information stored in the QR code.

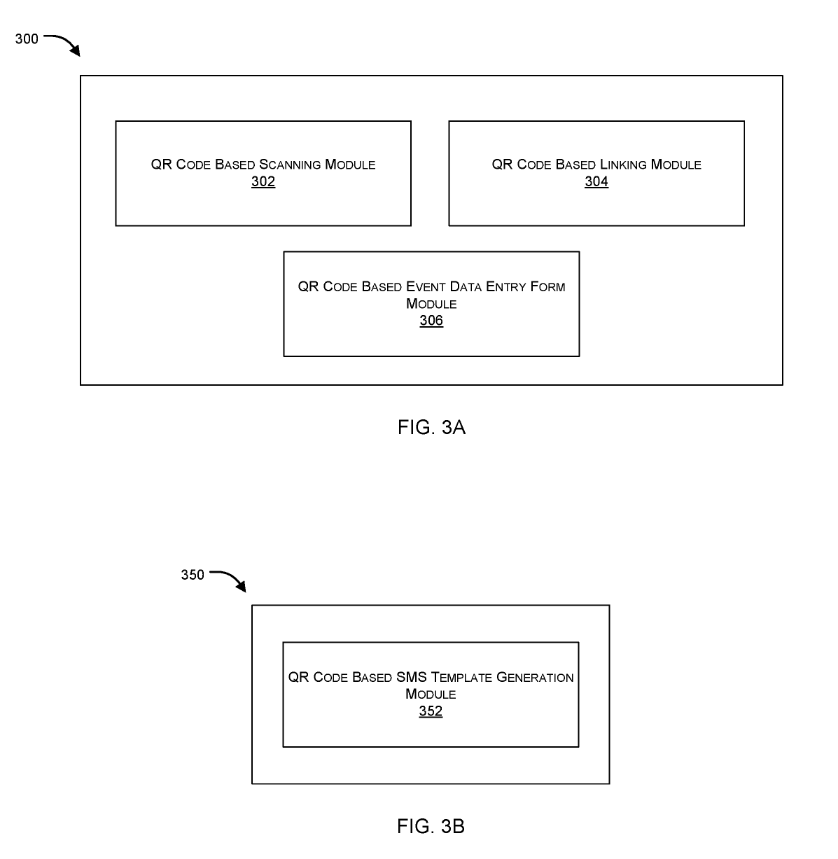

FIGS. 3A and 3B illustrate exemplary functional modules 300 and 350 of peripheral device 300 and peripheral device 350 of a Livestock Herd Database Management system of the present disclosure, wherein the functional modules of the device 300 can include a QR code based scanning module 302, a QR code based linking module, and a QR code based event data entry form module 306.

In an aspect, QR code based scanning module 302 can be configured to enable a device 300 to scan a QR coded ear Tag and/or premises/animal identification card, wherein such scanning of QR coded ear tag and/or premises/animal identification card can enable identification of a particular livestock/animal and reading of a dynamic URL/Short URL. In another aspect, QR code based linking module 304 can be configured to process the dynamic URL/short URL to operatively couple with the proposed system/server. In yet another aspect, QR code based event data entry form module 306 can be configured to enable retrieval of an event data entry form the proposed system database, and open the same on the linked peripheral device for editing one or more livestock records.

In an exemplary embodiment, the QR code generated can include encrypted information. In an exemplary implementation, information associated with the animal or program strings can be encrypted and converted to specific QR code and printed on the ear tag and/or premises/animal identification card or any other object. In an exemplary implementation, the QR code based scanning module 302 can be configured to enable the peripheral device to scan a QR code, which may include encrypted information, and decrypt the encrypted information/string, such as animal's identification number or unique livestock or other premises number or any other unique string generated. The scanned QR code can be processed by employing a dedicated program specially written for the purpose to decrypt the encrypted information stored in form of QR code.

The code can by scanned using a dedicated application having capability to decrypt the encrypted information/program string converted into the QR code. The dedicated application can be configured at registered peripheral device, for example a cell phone. The module 304 can be configured to enable linking/opening of animals' data file for browsing or data update once the scanned information is decrypted by the module 302. Storing the program strings/information in encrypted form and enabling access of information only by registered peripheral device, enables high data credibility and security. In an exemplary implementation, the peripheral device may have local database which can be accessed by the dedicated application for retrieving information associated with QR code and update part of the information or add new data. The dedicated application can scan the QR code to identify the content associated with the animal and update relevant data or add new data even when the peripheral device is off the internet/data connection. The dedicated application can save the updated data present on the local database on the central server as and when the peripheral device gets the internet access. The system therefore will be valuable in remote rural areas where animals are reared but internet connectivity is poor. Another advantage of the system is that the ear tag can code can be scanned only by service providers or other officers of the organizations whose cell phone numbers are registered. Only authorized persons will have access to the animal's data. The system therefore also confers substantial confidentiality to the data.

In an exemplary implementation, the peripheral device get data associated with the QR code or animal for the firm time, when the peripheral device gets scans the QR code and is connected to the central server. All relevant information associated with the particular animal can be uploaded or stored locally on the peripheral device, so as to enable access of relevant data even in offline mode.

In another embodiment, functional modules of the device 350 can include a QR code based SMS template generation module 352 that can be configured to enable a peripheral device to scan a QR coded ear Tag for generation of a standardized and preconfigured SMS template on the screen of the device, wherein such standardized and pre-configured SMS template can be used for updating livestock specific record/data on the system of the present disclosure.

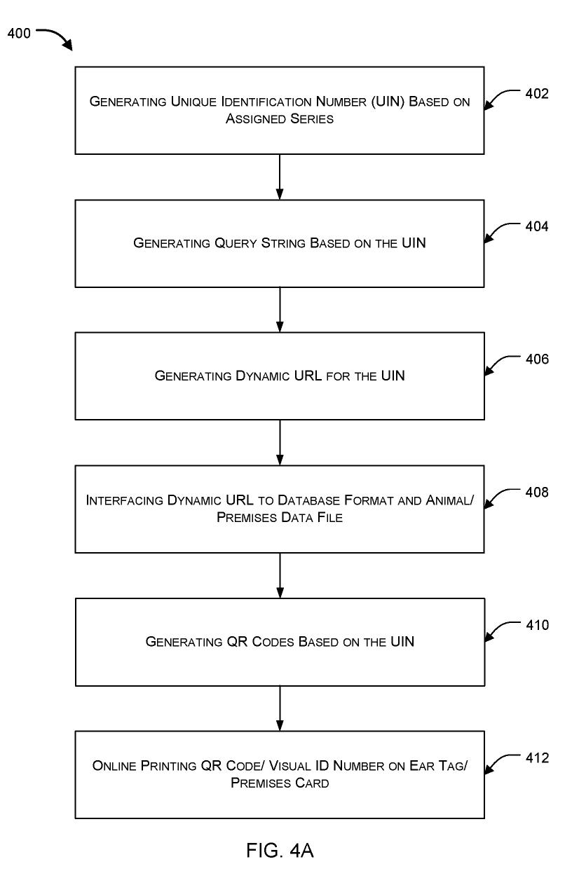

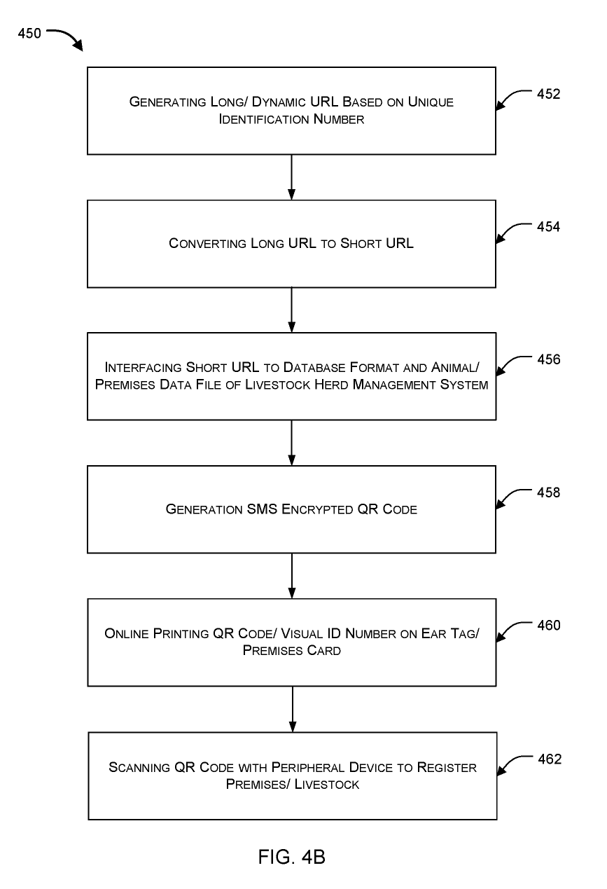

FIG. 4A illustrates an exemplary method 400 for on-line printing of QR coded ear tag of a livestock herd database management system of the present disclosure, wherein such method, at step 402, can include generating a Unique Identification Number (UIN) based on an assigned/allocated series. In an aspect, the assigned/allocated series can be uniquely identifiable for each location site. In another aspect, assigned/allocated series can be as per defined national and international standards (ICAR 2009) and UIN can be any 12-15 digit alphanumeric number, whereby UIN can be linked uniquely to one livestock/animal and record/data file created with each UIN can be a uniquely identifiable record in Livestock Herd Management System of the present disclosure.

At 404, the method can include the step of creating a query string based on the UIN, wherein the query string can direct to the linked livestock/animal record/data on Livestock Herd Management System of the present disclosure. In another aspect, each such query string can be used to open most-likely-event form on a Peripheral Device for updating/editing/modifying livestock/animal record/data file on Livestock Herd Management System.

At 406, the method can include the step of generating a dynamic URL for each UIN, wherein each query string can be converted to a corresponding dynamic URL for the respective UIN by inserting say a ‘query generation function’ and saving the same into the proposed System, wherein the dynamic URL can be linked to the respective livestock/animal record/data file.

At 408, the method can include the step of linking/interfacing each dynamic URL to the respective livestock/animal record/data file, which is stored in a database/repository of the proposed system so that each dynamic URL can provide a unique link to only one record/data file of the system.

At 410, the method can include the step of converting each dynamic URL to a corresponding QR Code such that the QR Code can be uniquely identified/linked with only one UIN.

At 412, the method can include the step of issuing an on-line command for printing of QR codes/tags/cards (with or without visual unique identification numbers), wherein such QR coded tags/cards can be randomly assigned. In another aspect, QR coded tags/cards can be made from synthetic polymer/plastic/recycled paper/any other printable material. In another aspect QR Coded Ear Tags with visible Unique Identification Number can be made of polyurethane or any other polymeric, synthetic, metallic or any other suitable material.

FIG. 4B illustrates an exemplary method 450 for generation of a unique short URL-SMS-QR coded ear tag for livestock data update. According to one implementation of the method, step 452 includes creating a long/dynamic URL based on the UIN as explained at FIG. 4A above. At step 454, the long URL can be converted into a short URL using freely available software applications, wherein such short URL can be non-visible. In another aspect, specially developed software applications can be used for converting long URL to short URL. At step 456, the short URL can be interfaced with a database format of the proposed system whereby each short URL can be linked, uniquely and singularly, to one livestock/animal/premises data file on a database of the system.

At step 458, each short URL can be used for generation of a SMS encrypted QR code such that the SMS encrypted QR code can be linked to a Unique Identification Number (UIN). At step 460, an on-line command can be given for printing the QR coded Cards/Ear Tags along with Visual Unique Identification Number, wherein such QR Coded Ear Tag and/or QR Coded Premises Card can be randomly assigned as explained at FIG. 4A above. In another aspect, QR Coded Ear Tags and/or QR Coded Premises Cards can be made from synthetic polymer/plastic/recycled paper/any other printable material. In another aspect QR Coded Ear Tags with visible Unique Identification Number can be made of polyurethane or any other polymeric, synthetic, metallic or any other suitable material.

At step 462, the QR Coded Ear Tag/QR Coded Premises Card can be scanned by means of a peripheral device, which can allow for opening of the registration form on the peripheral device and enables registration of the livestock/animal/premises on the proposed system, and wherein such registration can include creation of a new data file. In another aspect, scanning of QR Coded Ear Tag/QR Coded Premises Card with a peripheral device can also allow for opening of a standardized and pre-configured SMS Template on the device, wherein the SMS template can be used for creating a new record/data file and/or updating existing data file on database of the proposed system. In another aspect, data file creation/editing/modification can only be done after proper validation/authentication of the device being used for the process.

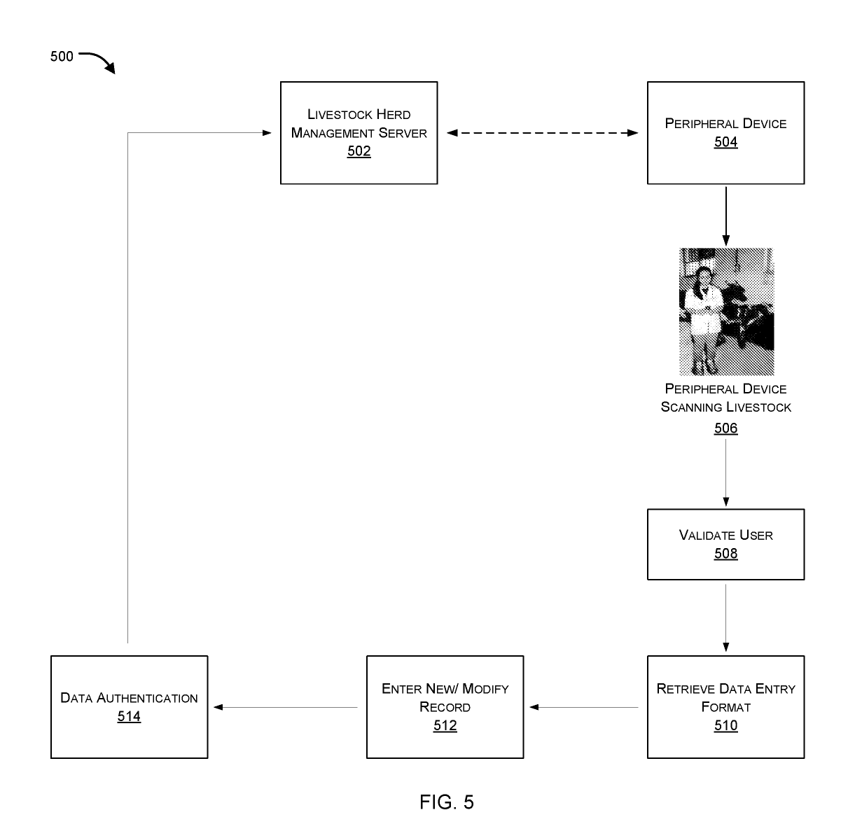

FIG. 5 illustrates an exemplary process for data update protocol 500 that uses a dynamic URLQR code based protocol for livestock herd database management system of the present disclosure, wherein such data update process can include scanning of a QR code that is affixed on a livestock/animal by means of a peripheral device 504, wherein the peripheral device 504 can be operatively coupled with, say a server 502. Block 506 shows application of the peripheral device 504 on an animal, wherein based on the scanning output, user of the device 504 can be validated/authenticated based on one or a combination of say a unique identification code of the user, username/password of the user, SIM/phone number, based on which it can be ascertained if the user is a farmer/veterinary/par-veterinary/AI worker/etc. Validation step can be carried out as shown in block 508, wherein a validation protocol can be incorporated to validate the user 504 and to then verify the Unique Identification Number associated with the QR code, based on which data entry form 510 for the respective livestock can be retrieved/opened on the peripheral device 504. In another aspect, opening of the most-likely-event data entry form on the peripheral device 504 can only happen if the logger is authorized/validated to enter data. User/logger can enter new records/data and/or update/edit/modify existing data file by making necessary entries/modifications on the most-likely-event data form 510, and upload the same to the server 502. At the server 502, uploaded data can be checked/verified, wherein such authentication can include verifying if the livestock/animal is registered with user/farmer and/or livestock/animal is of eligible age and/or livestock/animal is open for breeding and/or sire is registered and of same breed and/or AI data in case of breeding and/or such other factors. Data file on the proposed system can only be updated if the uploaded data can be successfully authenticated, as shown in at block 514.

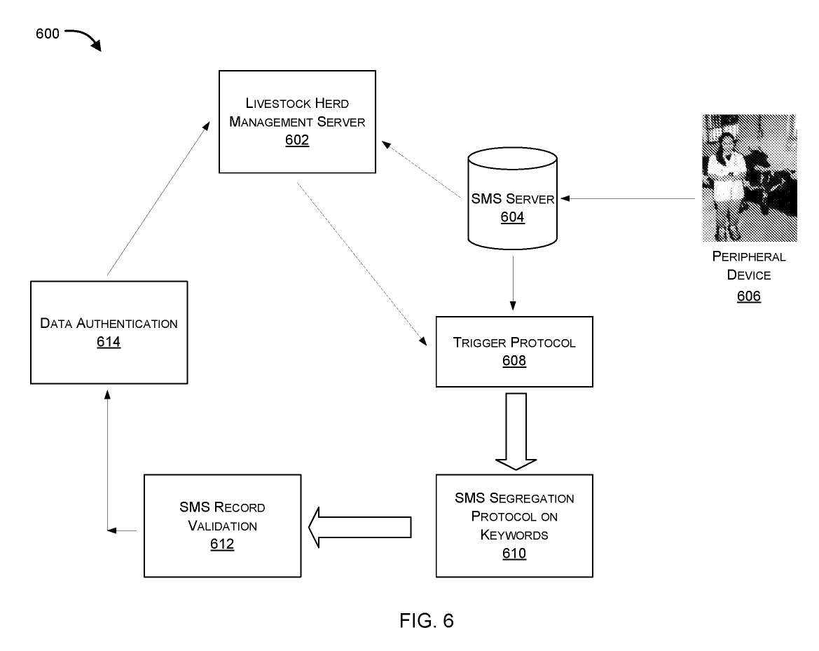

FIG. 6 illustrates an exemplary process for data update protocol 600 and process using SMS-QR code system of Livestock Herd Database Management System of the present disclosure, wherein such process can include scanning of QR Coded Ear Tag affixed on a livestock/animal by a user using a peripheral device 606, whereby the peripheral device 606 of the user operatively couples with an SMS server 604 and triggers an SMS protocol 608. In an implementation, the trigger SMS protocol 608 can trigger a livestock herd management server 602 and an SMS template can be presented on screen of the peripheral device 606, wherein such SMS template can include SMS segregation protocols and keywords 610. If validation is successful at 612, user can be authorized to update the record. In another aspect, if data code is correct, data can be uploaded for authentication at block 614. In case the data has not been sent from the farm-side or the code(s) are found not in correct format, an SMS can be sent to the user advising him/her to use correct data code. At the server 602, uploaded data can be checked for authentication 614, wherein such authentication can include verification of whether the livestock/animal is registered with the user/farmer and/or whether the livestock/animal is of eligible age and/or whether the livestock/animal is open for breeding and/or whether sire is registered and is of same breed and/or AI data in case of breeding and/or such other factors. Data file on Livestock Herd Management System can only be updated/edited/modified only if the uploaded data is successfully authenticated.

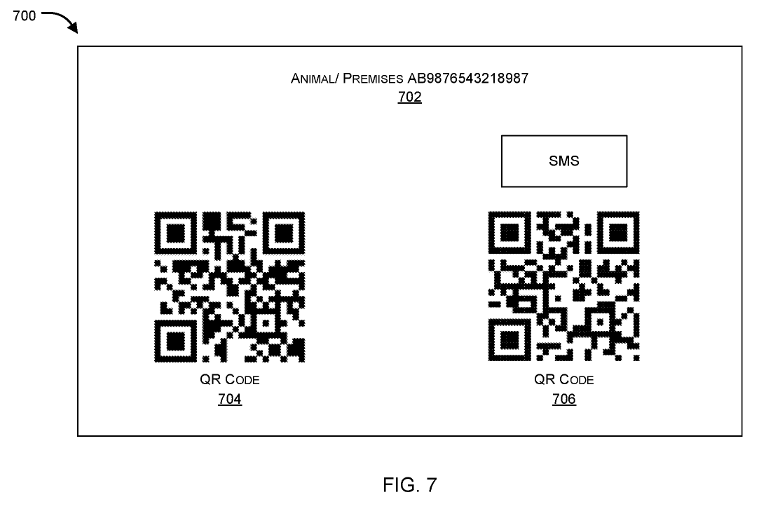

FIG. 7 illustrates an exemplary QR coded premises card 700 of a livestock herd database management system in accordance with an embodiment of the present disclosure, wherein the card 700 can be printed with a 12-15 digit alphanumeric number 702, wherein such 12-15 digit number 702 can be a Unique Identification Number (UIN) generated based on some assigned series or national and international standards. In another aspect, such 12-15 digit alphanumeric numbers 702 can uniquely identify a livestock/animal or premises to which it can be assigned/attached. In another aspect, such premises can be livestock premises site location such as farmhouses/ranches/dairies/etc. QR Coded Premises Card 700 can also include two QR codes 704 and 706 that can be embedded in premises card 700, wherein QR Code 704 can be embedded with a dynamic URL, wherein scanning of the QR code 704 by a peripheral device can link the peripheral device with a corresponding database file that is stored/configured on the proposed system. QR code 706 can be further earmarked with text reading SMS, wherein scanning of the QR Code 706 with a peripheral device can enable the device to link with a dedicated SMS server using an embedded short URL of the proposed system. Linking of the peripheral device with the SMS server can enable a standardized and pre-configured SMS template to open on the peripheral device, wherein the SMS template can be used for creating a new record and/or for updating existing linked data files on the database of the proposed System. In another aspect, such QR coded premises card 700 can be made from any polymeric material or recycled paper or thin metal sheet or any other such material.

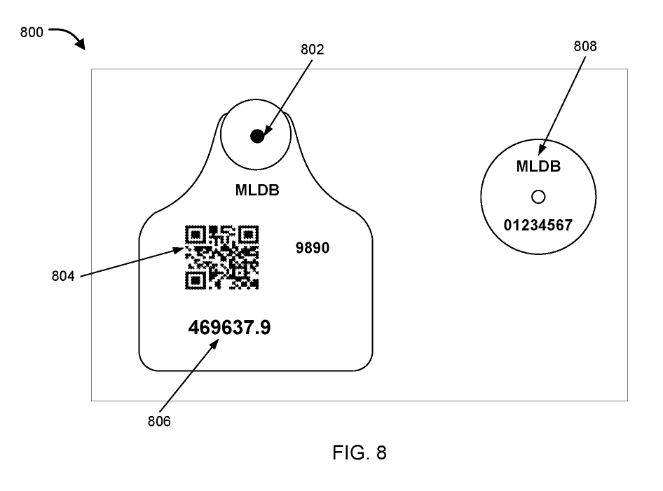

FIG. 8 illustrates an exemplary QR code ear tag 800 of a livestock herd database management system of the present disclosure, wherein the QR code tag can be made from synthetic polymer/plastic/recycled paper/any other printable material. In another aspect, the QR coded ear tag with visible Unique Identification Number can be made of polyurethane or any other polymeric, synthetic, metallic or any other suitable material. In another aspect, QR code tag 800 can be provided with a means 802 for attachment to livestock/animal. The tag can further include a QR code 804, wherein scanning of the code can enable a peripheral device to connect with a linked database file on the proposed system. QR tag 800 can also be printed with a visible 12-15 digit Unique Identification Number 806, along with optionally being printed with a premises identification number 808.

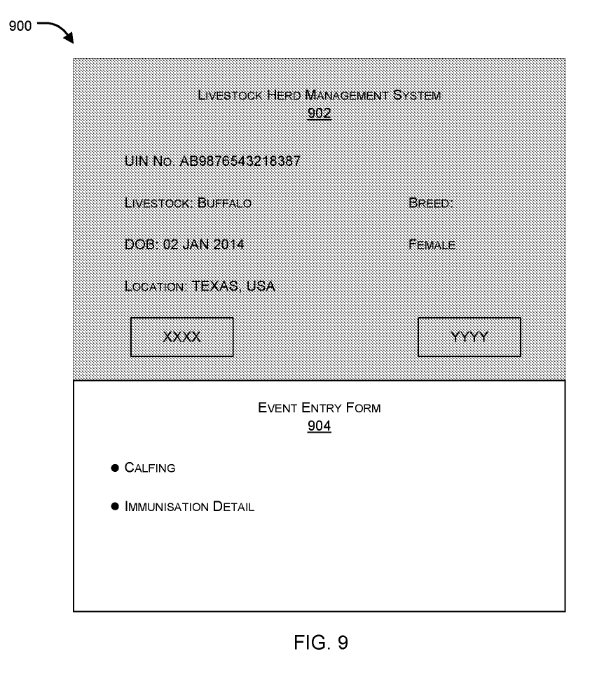

FIG. 9 illustrates an exemplary screen shot 900 of an SMS template that is presented on the display/screen of the peripheral device after a QR coded tag of a livestock is scanned by the device in accordance with an embodiment of the present disclosure. In an aspect, the SMS template can be used for securely creating a new record data file and/or for updating an existing data file on a database of the proposed system. In an aspect, the SMS template 900 can be configured with a non-editable part 902 and an editable part 904, wherein the non-editable part 902 can include data that can only be viewed by the user of peripheral device. In an aspect, the non-editable part 902 of the SMS template 900 can be populated with information such UIN number, type, breed, sex, date of birth etc. for livestock/animal whose data has been accessed. In another aspect, non-editable part 902 can also include coded keywords that can be used by SMS server to validate SMS message sent by the peripheral device. In another aspect, code keywords can also be entered in the editable part 904 of the SMS template 900, if the template 900 has been so configured. In another aspect, editable part 904 can provide either a pre-configured or user configured space for user to enter data that needs to be either appended/edited to existing linked data file of the proposed system. As already explained above, such modification to the existing data file can be updated on the system only after proper validation and authentication to ensure both security and creditability of database at all times.

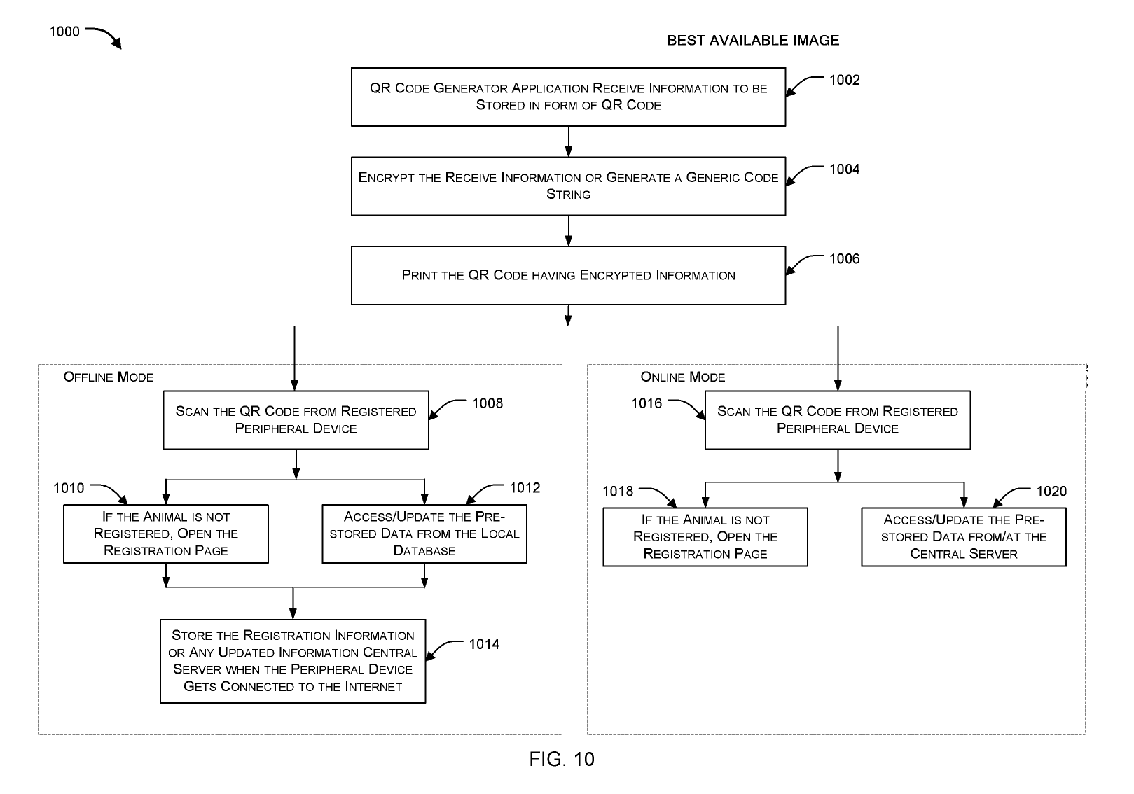

FIG. 10 illustrates an exemplary block diagram of the system enabling retrieval of encrypted information in form of QR code and enabling updation of data even in offline mode in accordance with an embodiment of the present disclosure. In an exemplary implementation, information associated with the animal or program strings can be encrypted and converted to specific QR code and printed on the ear tag and/or premises/animal identification card or any other object. As shown in FIG. 10, a QR code generator application can receive information to be stored in form of QR code as shown at block 1002, encrypt the received information or generate a generic code string as shown at block 1004, and print the QR code having encrypted information as shown at block 1006. In an exemplary implementation, the QR code generator application can receive information, for example identification information, location information etc. associated with the animal, livestock or premises and encrypt the received information or generate generic code strings before printing them on the QR code. As one may appreciate, information, for example ID information, of URL etc. stored in the QR code can't be accessed merely by scanning the QR code. In an exemplary implementation, a dedicated application can be provided for scanning the QR code and decrypting the information stored in the QR code. A dedicated application can be installed on authorized peripheral devices using which the QR code can be scanned and information stored in form of QR code can be decrypted.

The dedicated application can enable the peripheral device to scan a QR code which may include encrypted information and decrypt the encrypted information/program string, such as animal's identification number or unique livestock or other premises number or any other unique string generated. The scanned QR code can be processed by employing the dedicated application specially written for the purpose to decrypt the encrypted information stored in form of QR code. The dedicated application can be configured to enable linking/opening of animals' data file for browsing or data update once the scanned information is decrypted.

The peripheral device having the dedicated application can have local database storing information related with animals of particular area or for animals for which person carrying the peripheral device is authorized to access/update the data. The peripheral device on which the dedicated can be installed can be device of farmer or service person authorized to access the data related to particular animals. In an exemplary implementation, the peripheral device enables access of data even in offline mode or in on-line mode. When in offline mode, the peripheral device can scan the QR code as shown in block 1008 and perform different function in offline mode. For example, if the animal is not registered, the dedicated application can open the registration page, as shown at block 1010, or access/update the pre-stored data from the local database as shown at block 1012. In an exemplary implementation, the registration information or any updated information can be stored on central server when the peripheral device gets connected to the internet as shown at step 1014. When in online-mode, the peripheral device can scan the QR code as shown in block 1016 and perform different function in offline mode. For example, if the animal is not registered, the dedicated application can open the registration page as shown at block 1018, or access/updated the data from/at central server as shown at step 1020.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Invention

The present disclosure provides an ear tag printed with, in addition to visual identification number, one or more dynamic shortened URL in QR code format with string to connect users to animal's data file on a web-server to enable traceability.

The present disclosure provides an ear tag printed with URL and/or SMS, and a string in QR code that, apart from identification number, can also carry animal's data for update and traceability.

The present disclosure provides a low cost and efficient QR code based secure, credible, and efficient livestock data collection and herd database management system that can be based on, for instance, cloud based applications and can use a centralized web/application based server.

The present disclosure provides a low cost and efficient QR code based secure, credible, and efficient livestock data collection and database maintenance system that can function using peripheral devices and dynamic URL and/or short URL for linking to storage database.

The present disclosure provides a livestock data management system based on user and livestock authentication.

The present disclosure provides a livestock data management system whereby users can be authenticated based on their mobile number/SIM number.

The present disclosure provides a livestock data management system whereby livestock data can be validated using GIS location information.

1. A system for livestock management comprising:
a QR code based scanning module configured to enable a peripheral device to, for its respective livestock premise, scan a QR coded tag that is operatively coupled with a livestock; and
a QR code based linking module configured to enable the peripheral device to, using the scanned QR coded tag, retrieve details of the livestock from a database that is operatively coupled with the peripheral device through a network.

2. The system of claim 1, wherein the peripheral device is operatively coupled with a server, and wherein the server comprises a plurality of databases storing information pertaining to one or more livestock of one or more livestock premises, and wherein the databases are configured/categorized based on any or a combination of type of livestock, parameters of livestock premises, and attributes of peripheral devices.

3. (canceled)

4. The system of claim 1, wherein the system further comprises a QR code based event entry data form module that is configured to enable performance of any or a combination of updation, deletion, modification, and addition actions on the retrieved details of the livestock.

5. The system of claim 1, wherein scanning of the QR coded tag comprises reading of dynamic and/or short URL associated with the QR code, and wherein based on the read dynamic and/or short URL, details of the livestock are retrieved.

6. The system of claim 1, wherein the system further comprises a QR code based SMS template generation module that is configured to, based on the scanned QR coded tag, generate a SMS template on the peripheral device and send a SMS to the database to retrieve the details of the livestock, and present the retrieved details on the SMS template, and wherein said retrieved details to be presented in the SMS template are retrieved from a SMS server.

7. (canceled)

8. The system of claim 1, wherein the QR coded tag is configured on a livestock card that is tagged onto respective livestock, and wherein the livestock card further comprises a unique identification number (UIN).

9. (canceled)

10. The system of claim 1, wherein before receiving the details of the livestock from the database, a computing device operatively coupled with the database authenticates the peripheral device based on matching of geographical location the peripheral device with stored GIS coordinates.

11. The system of claim 1, wherein the peripheral device comprises any of a mobile phone, a smart phone, a laptop, and a tablet PC, and a portable computing device, and wherein the peripheral device is validated based on any or a combination of phone number, IP address, IMEI number of the device, location of the device, and a unique identifier of the device.

12. The system of claim 1, wherein the system further comprises a peripheral device based registration module configured to enable registration of the peripheral device with a server that is operatively coupled with the peripheral device and with the database, wherein said peripheral device is able to scan a QR coded tag only after registration.

13. The system of claim 1, wherein the peripheral device is configured with a local database for storing information pertaining to the one or more livestock of one or more livestock premises, and wherein the local database is configured to sync with the database that is operatively coupled with the peripheral device through the network.

14. (canceled)

15. The system of claim 1, wherein the QR coded tag stores information in encrypted form, and wherein the peripheral device comprises a dedicated application that is configured to decrypt the encrypted information stored in the QR coded tag once the QR coded tag is scanned.

16. (canceled)

17. A method for livestock data capturing comprising the steps of:
enabling a peripheral device to, for its respective livestock premise, scan a QR coded tag that is operatively coupled with a livestock; and
enabling the peripheral device to, using the scanned QR coded tag, retrieve details of the livestock from a database that is operatively coupled with the peripheral device through a network.

18. The method of claim 17, wherein the peripheral device is operatively coupled with a server, and wherein the server comprises a plurality of databases storing information pertaining to one or more livestock of one or more livestock premises.

19. The method of claim 18, wherein the databases are configured/categorized based on any or a combination of type of livestock, parameters of livestock premises, and attributes of peripheral devices.

20. The method of claim 17, wherein the method further comprises the step of enabling performance of any or a combination of updation, deletion, modification, and addition actions on the retrieved details of the livestock.

21. The method of claim 17, wherein scanning of the QR coded tag comprises reading of dynamic and/or short URL/generic code associated with the QR code, and wherein based on the read dynamic and/or short URL, details of the livestock are retrieved.

22. The method of claim 17, wherein the method further comprises the step of, based on the scanned QR coded tag, generating a SMS template on the peripheral device and send a SMS to the database to retrieve the details of the livestock, and present the retrieved details on the SMS template, and wherein said retrieved details to be presented in the SMS template are retrieved from a SMS server.

23. (canceled)

24. The method of claim 17, wherein the QR coded tag is configured on a livestock card that is tagged onto respective livestock, and wherein the livestock card further comprises a unique identification number (UIN).

25. (canceled)

26. The method of claim 17, wherein before receiving the details of the livestock from the database, a computing device operatively coupled with the database authenticates the peripheral device based on matching of geographical location the peripheral device with stored GIS coordinates.

27. The method of claim 17, wherein the peripheral device comprises any of a mobile phone, a smart phone, a laptop, and a tablet PC, and a portable computing device, and wherein the peripheral device is validated based on any or a combination of phone number, IP address, IMEI number of the device, location of the device, and a unique identifier of the device, and wherein the peripheral device is configured with a local database for storing information pertaining to the one or more livestock of one or more livestock premises, wherein the local database is configured to sync with the database that is operatively coupled with the peripheral device through a network.

28. (canceled)

29. (canceled)

30. (canceled)

31. (canceled)
